(19) United States
(12) Patent Application Publication
(10) Pub. No.: US 2013/0279176 A1
(43) Pub. Date: Oct. 24, 2013

(54) Color Insensitive Scattering Pigment

(71) Applicants: Udayan Kanade, Pune (IN); Sanat Ganu, Pune (IN)

(72) Inventors: Udayan Kanade, Pune (IN); Sanat Ganu, Pune (IN)

(73) Assignee: I2IC CORPORATION, Foster City, CA (US)

(21) Appl. No.: 13/997,274

(22) PCT Filed: Dec. 26, 2011
(86) PCT No.: PCT/IB2011/055958

§ 371 Date: Jun. 24, 2013

(30) Foreign Application Priority Data
Dec. 24, 2010 (IN) 3524/MUM/2010

(51) Int. Cl. F21V 8/00

(52) U.S. Cl. CPC G02B 6/0001
USPC 362/311.01; 362/351; 423/430; 423/433; 423/554; 423/610; 423/622; 423/625

(57) ABSTRACT

A color insensitive scattering pigment is disclosed. In an embodiment, the scattering pigment is composed of particles of a range of sizes. In at least one subrange of the range of sizes, the particles are present in such relative proportions that the v/v concentration (volumetric concentration) of a particular size of particles is proportional to the size itself. In an embodiment, such a scattering pigment is included in light guides to scatter light from a primary light source.

### This application claims priority from provisional patent application 3524/MUM/2010 titled “Color Insensitive Scattering Dye” filed in Mumbai, India on 24th Dec. 2010.

### TECHNICAL FIELD

This invention relates to pigments. More particularly, it relates to pigments used for scattering light in light sources.

### BACKGROUND ART

For many applications, light from one or many point light sources should be spread evenly over a long length or a large area. Backlights for display systems, and office, home and architectural lighting are some important applications. In traditional systems, such spreading of light is achieved using diffusers or using etched/patterned light guides.

### SUMMARY

A color insensitive scattering pigment is disclosed. In an embodiment, the scattering pigment is composed of particles of a range of sizes. In at least one subrange of the range of sizes, the particles are present in such relative proportions that the v/v concentration (volumetric concentration) of a particular size of particles is proportional to the size itself. In an embodiment, such a scattering pigment is included in light guides to scatter light from a primary light source.

The above and other preferred features, including various details of implementation and combination of elements are more particularly described with reference to the accompanying drawings and pointed out in the claims. It will be understood that the particular methods and systems described herein are shown by way of illustrations only and not as limitations. As will be understood by those skilled in the art, the principles and features described herein may be employed in various and numerous embodiments without departing from the scope of the invention.

### BRIEF DESCRIPTION OF THE DRAWINGS

The accompanying drawings, which are included as part of the present specification, illustrate the presently preferred embodiment and together with the general description given above and the detailed description of the preferred embodiment given below serve to explain and teach the principles of the present invention.

FIG. 1 depicts a light source system comprising a primary light source and a light guide positioned to accept the light emitted by the primary light source, according to an embodiment.

FIG. 2 depicts a light source system comprising a primary linear light source and a surface light guide positioned to accept the light emitted by the primary linear light source, according to an embodiment.

FIG. 3 depicts a light source system, according to an embodiment.

FIG. 4 depicts an exemplary scattering profile for a particular pigment particle, according to an embodiment.

FIG. 5 depicts an exemplary size distribution profile for an exemplary pigment, according to an embodiment.

FIG. 6 depicts an exemplary size distribution profile for an exemplary pigment, according to an embodiment.

FIG. 7 depicts an exemplary size distribution profile for an exemplary pigment, according to an embodiment.

FIG. 8 depicts exemplary size distribution profiles of exemplary constituent pigments, according to an embodiment.

FIG. 9 depicts an exemplary apparatus for creating particles having a particular size distribution profile, according to an embodiment.

### DETAILED DESCRIPTION

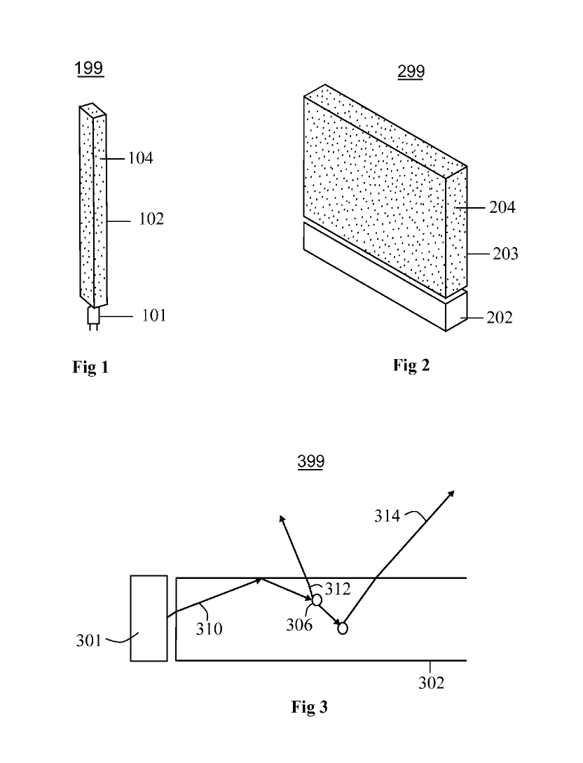

FIG. 1 depicts a light source system 199 comprising a primary light source 101 and a light guide 102 positioned to accept the light emitted by the primary light source 101, according to an embodiment. The light guide 102 includes a pigment 104 made of scattering particles. The pigment 104 may be present in a uniform concentration throughout the light guide or may be present in a varying concentration. The primary light source 101 may be any light source such as an LED or incandescent light source.

FIG. 2 depicts a light source system 299 comprising a primary linear light source 202 and a surface light guide 203 positioned to accept the light emitted by the primary linear light source 202, according to an embodiment. The surface light guide 203 includes a pigment 204 made of scattering particles, present in a uniform or varying concentration. The primary linear light source 202 itself may be a light source system as described in this invention, or may be any linear light source such as fluorescent tubes, LEDs, LED banks, electroluminescent light sources, etc.

FIG. 3 depicts a light source system 399, according to an embodiment. The primary light source 301 emits light 310 which enters the light guide 302, according to an embodiment. The light 310 is guided by the light guide 302 along it's length or surface, till it hits a scattering particle 306. Many such scattering particles are included as a pigment in the light guide 302. The scattering particle 306 deflects the light either in a direction which takes it out of the light guide 302, as depicted by ray 312 or in a direction such that it is further guided through the light guide 302. After a single or multiple such scatterings, light from the primary light source 301 exits the light guide 302 as depicted by ray 314. Thus, the body of the light guide 302 becomes a secondary source of light.

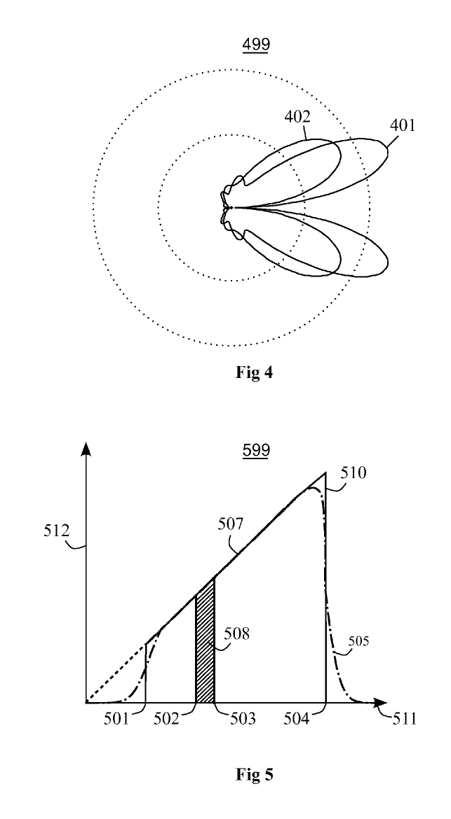

FIG. 4 depicts an exemplary scattering profile 499 for a particular pigment particle, according to an embodiment. A pigment is made out of spherical or spheroidal particles having a particular refractive index. The particles may also have a shape other than spherical or spheroidal. This pigment is dispersed throughout the transparent medium of a light guide to create a secondary light source. The pigment particle of a particular refractive index suspended in a medium of a different refractive index causes light impinging upon it to scatter in many directions. For example, the curve 401 depicts the amount of light deflected as a function of direction, drawn as a polar plot, for a particular particle size, refractive index and wavelength. The curve 402 depicts the amount of light deflected by the same particle for a different wavelength. Thus, a particular particle scatters different wavelengths of light differently.

If a pigment is made of scattering particles of this single size and refractive index, its scattering profile for different wavelengths will be different. It may be possible that light emanating out of a light source system including such a pigment will be observed to be differently colored when viewed from different directions. It may also be possible that different fractions of light of different wavelengths will be extracted at a particular location. This may result in the light source system including such a pigment to be differently colored in different parts.

FIG. 5 depicts an exemplary size distribution profile 599 for an exemplary pigment, according to an embodiment. The x-axis 511 represents the diameter of a spherical, spheroidal or other particle. The y-axis 512 represents the v/v concentration of particles of the particular diameter, as a density of the diameter parameter. The curve 510 depicts the function according to which the v/v concentration density of the particles varies with size of the particle. The total v/v concentration of particles having a diameter between a lower diameter 502 and an upper diameter 503 is the area under the curve 510 between said lower diameter 502 and upper diameter 503, namely, the area 508. In other words, the definite integral of the curve 510 represents the total v/v concentration of corresponding particles.

The curve 510 depicting the size distribution profile 599 has at least two parts, and at least one of these parts is a linear part. The linear part 507 of the curve 510 is a substantial part of the curve 510 where the v/v concentration density of the particles is directly proportional to the diameter of the particle. Thus, if the diameter of the particle is d, then the v/v concentration density of the particles is p times d where p is a constant of proportionality. The upper cutoff 504 of the curve 510 is a particle size where the linear part 507 ends. In an embodiment, the pigment has no or negligible particles having a particle size greater than the upper cutoff. The optional lower cutoff 501 of the curve 510 is a particle size where the linear part 507 begins. In an embodiment, the pigment has no or negligible particles having a size lesser than the lower cutoff. The corners between the linear part and the cutoffs may be sharp, as depicted by the curve 510 or may be smooth as depicted by curve 505. The curve 510 may also have parts which are not linear, i.e. where the v/v concentration density of the particles is not directly proportional to the diameter of the particle.

The particles of which the pigment is made may be non-spherical particles. The x-axis then represents a size parameter of the particle. The size parameter of a particle is a parameter directly proportional to the size of the particle. For example, if all the particles have the same shape (possibly non-spherical), two particles having different size parameters will have the same shape but different sizes, the different sizes having linear dimensions in the same proportion as the ratio of the size parameters. For example, if the particles are cubic in shape, the size parameter may be the side of the cube, or the diagonal of the cube. If the particles have varying (statistical) shape, the size parameter may be some average property of the particle, such as average diameter. In an embodiment, the particles have a varying (statistically determined) refractive index.

In an embodiment, the curve 505 or curve 510 depict the relative v/v concentration of particles, as a density of the size parameter, relative to the total volume of the particles. I.e. the concentration of all particles between a lower size parameter 502 and an upper size parameter 503 is the total volume of such particles as a fraction of the total volume of all the particles. This concentration will be numerically equal to the area 508 under the curve. The total area under the curve 505 or curve 510 will be one. The relative v/v concentration density function gives us the composition of the pigment, i.e. relative presence of particles of different size parameters, without indicating the dilution at which they are present in a body having a medium in which the particles are present. The pigment with a particular composition, i.e. a particular relative v/v concentration density function, may be present at a particular dilution (concentration) in the light guide of a light source. It may be present at different concentrations in different locations of the light guide. The actual concentration of a subset of particles may be found by multiplying the relative concentration of the subset of particles by the concentration of the pigment within the body.

In an embodiment, particles of diverse species are mixed. For example, different species may have different refractive indexes. Alternatively, different species may have different shapes. In an embodiment, at least one species among those mixed has at least one part of the size distribution profile where the v/v concentration density of the particles is directly proportional to the size of the particle. In another embodiment, each of the species mixed has at least one part of the size distribution profile where the v/v concentration density of the particles is directly proportional to the size of the particle.

In an embodiment, the refractive index of the particles is between 2.7 and 2.9, for example, the particles may be made of Titanium Dioxide, or more specifically, Rutile. The particles may be made of other transparent material such as Barium Sulfate, Aluminum Oxide, Calcium Carbonate, Zinc Oxide or Lead Carbonate, or organic or polymer pigment. In an embodiment, the pigment is titanium dioxide of spherical shape, the lower cutoff is 50 nm and the upper cutoff is 250 nm.

In an embodiment, the lower and upper cutoffs are chosen as follows. A particle of a particular size has a scattering cross section for a particular wavelength of particles. The ratio of the scattering cross section to the geometrical cross section of the particle is the scattering efficiency of the particle. The cutoffs are chosen to be around a maxima in scattering cross section or scattering efficiency plotted against particle size, for a wavelength that is approximately at the center of the operating range of wavelengths, i.e. the range of wavelengths that are to be scattered by the apparatus. For example, to create broad spectrum white light, the range of wavelengths may be the entire visible range. In an embodiment, the lower cutoff is chosen to be at or close to a minima (of scattering cross section or scattering efficiency) at a particle size smaller than the particle size at the said maxima. Similarly, the upper cutoff is chosen to be at or close to a minima at a particle size larger than the particle size at the said maxima.

In an embodiment, the maxima and minima are not with respect to scattering cross section or scattering efficiency, but with respect to the strongest light decay eigenvalue of the modal solution of the differential equation governing the light distribution and extraction in a light source including that pigment. For a light source having a light guide and a pigment, this strongest light decay eigenvalue (numerically the eigenvalue of smallest magnitude) is the asymptotic (over distance) rate at which light traveling in a light guide is diminished as a proportion of the total light traveling at that point of the light guide.

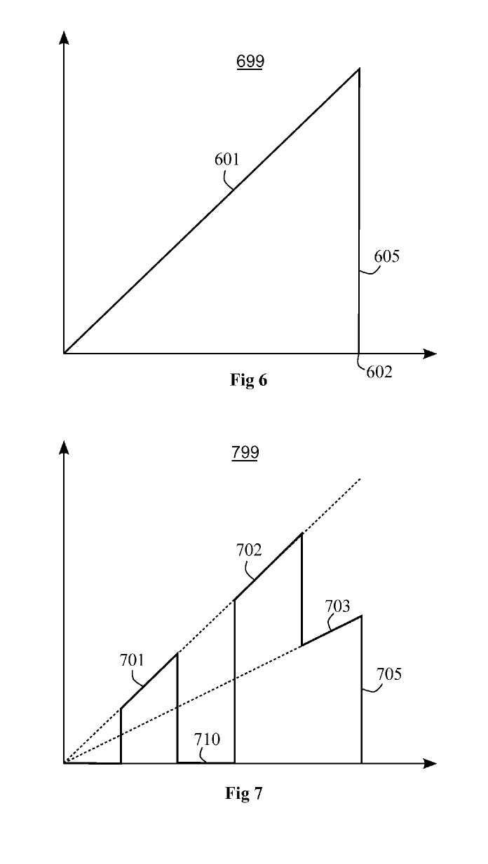

FIG. 6 depicts an exemplary size distribution profile 699 for an exemplary pigment, according to an embodiment. The curve 605 depicting the function according to which the v/v concentration density of the particles varies with the size of the particle, has a linear part 601 and an upper cutoff 602, but no lower cutoff. I.e. the particles from size zero to the size of the upper cutoff are included with the v/v concentration density of the particles directly proportional to the size of the particles.

FIG. 7 depicts an exemplary size distribution profile 799 for an exemplary pigment, according to an embodiment. The curve 705 depicting the function according to which the v/v concentration density of the particles varies with the size of the particle has many linear parts, such as linear part 701, linear part 702 and linear part 703. In each linear part, the v/v concentration density of the particles is directly proportional to the size of the particles, but the constant of proportionality may be different in different parts. The linear parts may be separated by regions of zero concentration such as region 710, or the linear parts may be adjoining each other, such as linear part 702 and linear part 703. The linear parts may have the same constant of proportionality, such as linear part 701 and linear part 702, or they may have different concentrations of proportionality, such as linear part 701 and linear part 703. Such a pigment, having multiple linear parts may be made by mixing pigments having a single linear part in particular proportions. The pigment may have particles having a particular refractive index or a particular distribution of refractive indices. The pigment particles may have a particular shape (such as spherical, square, etc.) or a particular distribution of shapes.

It is also possible to mix heterogeneous pigments to produce a single pigment. For example, a pigment of a particular refractive index and a linear part in its concentration density may be mixed with a pigment having a different refractive index, or a different shape, but having a linear part in its concentration density. For example pigments of different materials, such as titanium dioxide, barium sulphate may be mixed together.

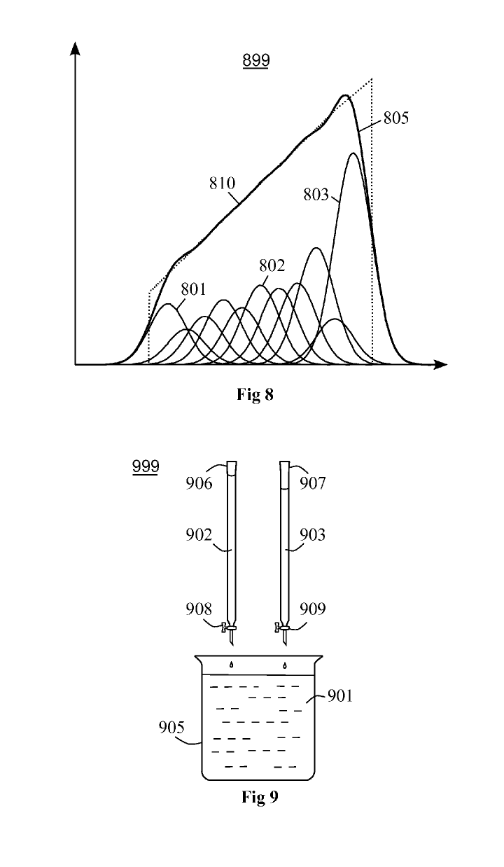

FIG. 8 depicts exemplary size distribution profiles 899 of exemplary constituent pigments, according to an embodiment. Size distribution profiles such as those represented by curve 801, curve 802 and curve 803 depict a pigment having a narrow size distribution. In an embodiment, the size distribution of a constituent pigment may be a normal distribution around a central size. Such a distribution may be approximately achieved by using particle manufacturing methods which can create accurate particle sizes, such as methods of sol-gel chemistry. In another embodiment, the size distribution of a constituent pigment may be a uniform distribution having a minimum and a maximum size. Such a distribution may be approximately achieved by using filtering techniques. Many such constituent pigments are mixed in accurate proportions to create a pigment having a linear part. For example, the constituent pigments depicted in the present figure are mixed to create a pigment having a size distribution profile represented by curve 805, which has an approximate linear part 810.

FIG. 9 depicts an exemplary apparatus 999 for creating particles having a particular size distribution profile, according to one embodiment. The flask 905 has a first reactant 901. Second reactant 902 is added, preferably at a slow rate through a first valve 908. The first valve 908 may be attached to a first burette 906 or other reservoir of chemical. An inhibitor 903 is added, preferably at a slow rate through a second valve 909. The second valve 909 may be attached to a second burette 907 or other reservoir of chemical. In an embodiment, the reaction mixture in the flask 905 is stirred continuously, or other reaction conditions such as temperature, the presence of catalysts, etc. are maintained. The first reactant 901 and second reactant 902 react chemically to produce particles. In an embodiment, such particles are spherical in shape. The size of the particles created is dependent on the concentration of inhibitor 903 in the reaction mixture in the flask 905. In an embodiment, as the concentration of inhibitor 903 increases over time, the size of the particles produced decreases. Thus, as inhibitor 903 is slowly added to the reaction mixture, smaller particles are produced. In an embodiment, the inhibitor limits the size of the particles that are produced after it is introduced, while not affecting particles already produced earlier. The rates of flow of the first valve 908 and second valve 909 are continuously varied to produce a mixture of particles having a required size distribution profile. More than two reactants may be used in the reaction, and more than one inhibitors may be used. Promoter chemicals, which tend to increase the size of the particle produced, may also be used.

In an embodiment, the first reactant 901 is a water and alcohol mixture. The second reactant 902 is titanium ethoxide. The inhibitor 903 is some acid or salt or a combination of the two. For example, the inhibitor may be hydrochloric acid. The salt may be sodium chloride (common salt). The particles generated will be spherical or spheroidal particles of titanium dioxide. Similarly particles of silica may be produced by using silicon ethoxide as the second reactant 902.

In an embodiment, the concentration of inhibitor is not increased but decreased over time. In this case, inhibitor may be present in the flask 905 to begin with, and a dilution is achieved over time by adding a diluting substance which may or may not take part in the reaction. In another embodiment, the concentration of inhibitor is not changed at all, but one of the reactants is introduced slowly into a flask having another reactant. The particles nucleated earlier become larger than the particles nucleated later, and this slow introduction of one reactant into another leads to a distribution of particle sizes. The growth of particles may be stopped by introducing an inhibitor, or removing the particles from the reaction mixture.

In an embodiment, a first container has reactants mixed in a large concentration, while also having a large concentration of inhibitor. This produces many particles of very small size. These particles are slowly introduced into a vessel having a smaller concentration of at least one of the reactants, but also a smaller concentration of the inhibitor. The lower concentration of inhibitor allows the particles to grow beyond their initially inhibited size, but the smaller concentration of reactants reduces the rate at which this growth will happen. Thus introducing particles over time causes the particles to grow to various degrees, thus giving a size distribution profile. The growth of all particles may be stopped by introducing the inhibitor in a large quantity, or removing the particles from the reaction mixture.

The same method of producing particles having a particular size distribution profile may be implemented using other apparatus instead of flasks, burettes and valves. Other containers such as pipes, reaction vessels, tanks etc. may be used, and many flow control mechanisms known in the art may be used.

Uses

The pigment of the present invention scatters light of different wavelengths in a similar manner. It may be used in any apparatus which uses scattering to distribute light over a surface, such as an elongated or sheet-form light guide with embedded scattering particles.

The pigment of the present invention may be used in a paint which reflects all wavelengths by the same amount. Such paints will reflect light of the same spectrum as the light that falls on the paint. Thus, it is a very “neutral” white color. Furthermore, such a neutral color may be achieved using a smaller coat of paint than is required with prior art technology. Such neutral color is very useful in optics laboratory instruments such as integrating spheres and luminaires having integrating cavities, to ensure accuracy of measurement of light spectra or fidelity reproduction of light spectra.

1. A pigment comprising particles that scatter light, wherein
the particles have a plurality of sizes distributed according to a size distribution profile, and
the size distribution profile has at least one substantial part where the v/v concentration density of the particle is directly proportional to the size of the particle.

2. The apparatus of claim 1 wherein the particles are spherical in shape, and the size of the particle is the diameter of the particle.

3. The apparatus of claim 1 wherein the particles have a statistically determined shape.

4. The apparatus of claim 1 wherein the particles of particle sizes other than those in the one substantial part are primarily non-existant.

5. The apparatus of claim 1 wherein the size distribution profile has at least two different substantial parts where the v/v concentration density of the particle is directly proportional to the size of the particle.

6. The apparatus of claim 1 wherein the particles are transparent.

7. The apparatus of claim 1 further comprising a light guide, the pigment included in the light guide.

8. The apparatus of claim 7 further comprising a primary light source, light from the primary light source entering the light guide in such a way as to be guided by the light guide till it hits a particle that scatters light.

9. A method comprising,
keeping a first reactant in a first container,
introducing a second reactant into the first container over time, and
changing the concentration of an inhibitor in the first container over time in such a way as to achieve a required size distribution profile, wherein,
the first reactant and second reactant react to form a particle, and
the concentration of the inhibitor determines the maximum size of the particle that may be produced.

10. The method of claim 9 wherein the concentration of the inhibitor in the first container is increased over time.
